(19) United States
(12) Patent Application Publication
(10) Pub. No.: US 2002/0191116 A1
(43) Pub. Date: Dec. 19, 2002

(54) System and data format for providing seamless stream switching in a digital video recorder

(76) Inventors: Damien Kessler, San Jose, CA (US); Ligang Lu, Somers, NY (US); Billy Wesley Beyers, JR., Indianapolis, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 09/841,140

(22) Filed: Apr. 24, 2001

(51) Int. Cl. H04N 5/38

(52) U.S. Cl. 348/723; 375/240.01

(57) ABSTRACT

A system and method for processing packetized video data. Encoded data representing a first video program having a first display resolution is received, and encoded data representing a second video program of a second display resolution lower than said first display resolution is received. Transmission identification information is generated for signaling a transition from said first display resolution to said second display resolution, and said first video program encoded data and said second video program encoded data and said identification information are incorporated into packetized data. Said packetized data are provided for output to a transmission channel.

### BACKGROUND OF THE INVENTION

1. Field of the Invention

The present invention relates to video processing systems, and, in particular, to apparatuses and methods for encoding first and second video streams with different resolutions and for seamlessly transitioning from one stream to another during decoding.

2. Description of the Related Art

Data signals are often subjected to computer processing techniques such as data compression or encoding, and data decompression or decoding. The data signals may be, for example, video signals. Video signals are typically representative of video pictures (images) of a motion video sequence. In video signal processing, video signals are digitally compressed by encoding the video signal in accordance with a specified coding standard to form a digital, encoded bitstream. An encoded video signal bitstream (video stream, or datastream) may be decoded to provide decoded video signals corresponding to the original video signals.

The term “frame” is commonly used for the unit of a video sequence. A frame contains lines of spatial information of a video signal. A frame may consist of one or more fields of video data. Thus, various segments of an encoded bitstream represent a given frame or field. The encoded bitstream may be stored for later retrieval by a video decoder, and/or transmitted to a remote video signal decoding system, over transmission channels or systems such as Integrated Services Digital Network (ISDN) and Public Switched Telephone Network (PSTN) telephone connections, cable, and direct satellite systems (DSS).

Video signals are often encoded, transmitted, and decoded for use in television (TV) type systems. Many common TV systems, e.g., in North America, operate in accordance with the NTSC (National Television Systems Committee) standard, which operates at (30*1000/1001) [symbol] 29.97 frames/second (fps). The spatial resolution of NTSC is sometimes referred to as SDTV or SD (standard definition TV). NTSC originally used 30 fps, which is half the frequency of the 60 cycle AC power supply system. It was later changed to 29.97 fps to throw it “out of phase” with power, reducing harmonic distortions. Other systems, such as PAL (Phase Alternation by Line), are also used, e.g., in Europe.

In the NTSC system, each frame of data is typically composed of an even field interlaced or interleaved with an odd field. Each field consists of the pixels in alternating horizontal lines of the picture or frame. Accordingly, NTSC cameras output 29.97×2=59.94 fields of analog video signals per second, which includes 29.97 even fields interlaced with 29.97 odd fields, to provide video at 29.97 fps.

Various video compression standards are used for digital video processing, which specify the coded bitstream for a given video coding standard. These standards include the International Standards Organization/International Electrotechnical Commission (ISO/IEC) 11172 Moving Pictures Experts Group-1 international standard (“Coding of Moving Pictures and Associated Audio for Digital Storage Media”) (MPEG-1), and the ISO/IEC 13818 international standard (“Generalized Coding of Moving Pictures and Associated Audio Information”) (MPEG-2). Another video coding standard is H.261 (Px64), developed by the International Telegraph Union (ITU). In MPEG, the term “picture” refers to a bitstream of data that can represent either a frame of data (i.e., both fields), or a single field of data. Thus, MPEG encoding techniques are used to encode MPEG “pictures” from fields or frames of video data.

MPEG-2, adopted in the Spring of 1994, is a compatible extension to MPEG-1, which builds on MPEG-1 and also supports interlaced video formats and a number of other advanced features, including features to support HDTV (high-definition TV). MPEG-2 was designed, in part, to be used with NTSC-type broadcast TV sample rates (720 samples/line by 480 lines per frame by 29.97 fps). In the interlacing employed by MPEG-2, a frame is split into two fields, a top field and a bottom field. One of these fields commences one field period after the other. Each video field is a subset of the pixels of a picture transmitted separately. MPEG-2 is a video encoding standard that can be used, for example, in broadcasting video encoded in accordance with this standard. The MPEG standards can support a variety of frame rates and formats.

An MPEG transport bitstream or datastream typically contains one or more video streams multiplexed with one or more audio streams and other data, such as timing information. In MPEG-2, encoded data that describes a particular video sequence is represented in several nested layers: the Sequence layer, the GOP layer, the Picture layer, the Slice layer, and the Macroblock layer.

To aid in transmitting this information, a digital data stream representing multiple video sequences is divided into several smaller units and each of these units is encapsulated into a respective packetized elementary stream (PES) packet. That is, the transport stream may contain one program or multiple programs with independent timebases multiplexed together. For transmission, each PES packet is divided, in turn, among a plurality of fixed-length transport packets, where each program may consist of one or more PES with a common timebase. Each transport packet contains data relating to only one PES packet. An elementary stream consists of compressed video or audio source material. PES packets are inserted into transport stream packets, each of which carries data of one and only one elementary stream. The transport packet also includes a header that holds control information to be used in decoding the transport packet.

Thus, the basic unit of an MPEG stream is the packet, which includes a packet header and packet data. Each packet may represent, for example, a field of data. The packet header includes a stream identification code and may include one or more time-stamps. For example, each data packet may be over 100 bytes long, with the first two 8-bit bytes containing a packet-identifier (PID) field. The PID of the transport packet header identifies uniquely the elementary stream carried in that packet. In a DSS application, for example, the PID may be a SCID (service channel ID) and various flags. The SCID is typically a unique 12-bit number that uniquely identifies the particular data stream to which a data packet belongs.

In addition to carrying program information, transport packets also carry service information and timing references. The service information specified by the MPEG standard is known as program specific information (PSI) and it is arranged in four tables, each of which is tagged with a PID value of its own.

The transport stream will eventually have to be de-multiplexed by an integrated receiver decoder (IRD) located at the receiver side. Therefore, it must carry synchronization information to allow compressed audio and video information to be decoded and presented at the right time. A clock at the encoder generates this information. Where there are multiple programs in the transport stream, each with a separate timebase, a separate clock is used for each program. These clocks are used to create time stamps that provide a reference to the decoder for the correct decoding and presentation of audio and video as well as time stamps that indicate the instantaneous values of the clock itself at sampled intervals.

The time stamps that indicate the time at which information is to be extracted from the decoder buffer and decoded are called decoding time stamps (DTS). Those that indicate the time at which a decoded picture with its corresponding sound is presented to the viewer are called presentation time stamps (PTS). There are separate PTSs for audio and video designed to convey accurate relative timing between the two. One further set of time stamps indicates the value of the program clock. These stamps are called program clock references (PCR). The decoder uses these PCRs to reconstruct the program clock frequency generated by the encoder.

In a DSS MPEG system, an MPEG-2 encoded video bitstream may be transported by means of DSS packets when DSS transmissions are employed. DSS systems allow users to receive directly TV channels broadcasted from satellites, with a DSS receiver. The DSS receiver typically includes a small 18-inch satellite dish connected by a cable to an MPEG IRD unit. The satellite dish is aimed toward the satellites, and the IRD is connected to the user's television in a similar fashion to a conventional cable-TV decoder. Alternatively, the IRD may receive a signal from a local station. These signals may include local programming as well as retransmissions of national programming received by the local station via satellite from the national network.

In the MPEG IRD, front-end circuitry receives a signal from the satellite and converts it to the original digital data stream, which is fed to video/audio decoder circuits that perform transport extraction and decompression. In particular, a transport decoder of the IRD decodes the transport packets to reassemble the PES packets. The PES packets, in turn, are decoded to reassemble the MPEG-2 bitstream that represents the image. For MPEG-2 video, the IRD comprises an MPEG-2 decoder used to decompress the received compressed video. A given transport data stream may simultaneously convey multiple image sequences, for example as interleaved transport packets.

In typical North American television networks, a network station of a given television network typically transmits a HD feed by satellite. This signal is received directly by user IRDs rather than being retransmitted by local stations of local affiliates, to more efficiently use transmission bandwidth. The local stations typically also receive a network video feed, to provide synchronization and other signals such as permission to broadcast a local program or commercial to the IRDs in the local station's geographic area. The local feeds are typically uplinked from the local station to the satellite, which then transmits both the network HD feed and the local programming simultaneously. These may or may not be transmitted using the same transponder (i.e., on the same transmission “channel”).

If both the HD stream and SD stream are received by the IRD (either in the same channel or in different channels), and if the user's IRD simply switches between bitstreams to decode the local commercial, undesirable artifacts can be introduced. For example, during the time needed to switch to the new program and acquire new data, the IRD may need to display black frames or repeat the last decoded picture over and over until the new program data is acquired.

An alternative approach, which avoids such artifacts, would be to insert the local content in the video domain, by first decoding the HD bitstreams and inserting the local commercial whenever it is allowed and re-encode. However, this increases the system cost at the local station because of hardware needed to decode and re-encode HD signals. Another approach would be to insert another bitstream for the local commercial in the bitstream domain to replace the original HD feed. This is called bitstream splicing. However, this approach also adds additional cost to the overall system.

### SUMMARY OF THE INVENTION

The idea of the invention is to utilize two video streams with different resolutions with a digital video decoder to switch from one video resolution to another. By storing the video data from each stream in a buffer, the digital video decoder can switch between each video stream seamlessly, provided the buffer holds and outputs video data to match the time it takes to switch video streams.

### BRIEF DESCRIPTION OF THE DRAWINGS

FIG. 1 shows a digital video broadcast system, in accordance with an embodiment of the present invention;

FIG. 2 illustrates the variations of the average buffer occupancy against time for three different decoders; and

FIG. 3 illustrates the VBV delay variations for the HD streams, employed by the HD encoder and decoder buffers of the system of FIG. 1 to achieve the seamless stream switching of the present invention.

### DESCRIPTION OF THE PREFERRED EMBODIMENT

In the present invention, there is provided a method and system for seamless stream switching in a digital video decoder. As used herein, “stream switching” refers to a given IRD switching from one digital data (e.g., video) stream to another, whether or not both data streams are transmitted in the same channel.

In a preferred embodiment, a first video stream having a first resolution (e.g., HD) is transmitted by a local station, on the same channel as a second video stream having a second resolution (e.g., SD). (Different channels could also be used.) The first stream contains a main program, e.g. a main TV feed received from a national television broadcast network of which the local station is an affiliate. The second stream contains local content, such as a local TV news program or a local commercial.

In this embodiment, the local station receives the HD stream and generates the local SD stream. Both are transmitted, preferably on the same channel, via a suitable transmitter, e.g. satellite or radio tower. The two streams, the HD and SD encoders, and the IRD are configured, as described in further detail below, so that the IRD can seamlessly switch from the HD to the SD stream, and back. The switching between streams is seamless because it is done without noticeable video artifacts, such as black screens, video freezes or repeats, and the like.

Thus, the present invention provides an IRD that switches at specific times from one video stream, such as an MPEG video stream, to another in a seamless way. In an embodiment, upon reception of a specific signal, the IRD automatically tunes to another program, whose characteristics (tuning frequency, PIDs, etc.) have been previously transmitted to the IRD. While doing so, the IRD keeps decoding the data from the previous video program, which is already in its buffer. If there is enough data in the buffer to cover the whole time needed to switch to the new program and acquire new data, the transition is seamless, and there is no need to display black frames or to repeat the last decoded picture over to mask the absence of valid data. In order to achieve the seamless channel switching of the present invention, the two video streams are synchronized together. Also, the locations in time of the splicing points are fully known by both encoders and decoders (IRDs). The constraints to be met to allow for such a seamless transition are described in further detail below.

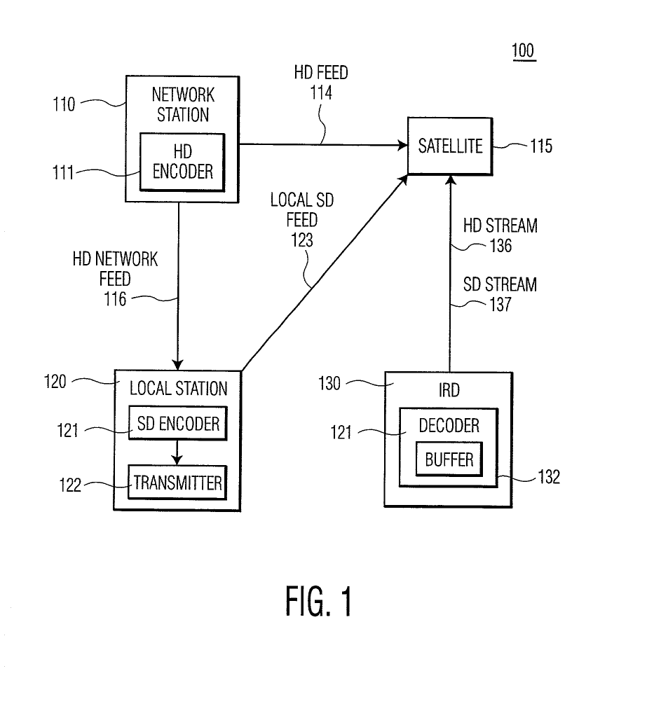

Referring to FIG. 1, there is shown a digital video broadcast system 100, in accordance with an embodiment of the present invention. System 100 includes network station 110, which includes a HD encoder 111. HD encoder 111 generates a HD feed 114 comprising a plurality of HD video streams, which comprise the main feed of the network. This HD feed 114 is transmitted to satellite 115 for retransmission to user IRDs. The HD network feed 116, generated at the network station 110, is also typically transmitted to the local stations of the local affiliates of the network, such as local station 120.

Local station 120 includes a SD encoder 121 for encoding local content into a SD video stream. A transmitter 122 transmits (uplinks) a local SD feed 123, comprising a plurality of local SD streams, to satellite 115, for retransmission to IRDs of a given local area associated with local station 120, such as IRD 130. A HD stream 136, from HD feed 114, and a SD stream 137, from local SD feed 123, are received by an IRD 130 of a given user from satellite 115. If the satellite uses the same transponder to transmit these datastreams, they are in the same channel. Switching from the HD stream 136 to the SD stream 137 by IRD 130 would thus involve switching streams but not channels. If the streams are transmitted by satellite 115 using different transponders, however, stream switching also comprises switching channels.

Thus, for example, the HD stream 136 received by IRD 130 may be part of an HDTV feed broadcast nationwide to avoid having to duplicate the signal and generate local feeds, which would take up too much of the available bandwidth. SD stream 137 represents local programming, such as commercials, local news, and other local programming. In order to “insert” the local programming carried in the SD stream 137 “into” the HD program at specific times, IRDs currently decoding the HD program are instructed by an appropriate stream-switch signal to switch to SD stream 137. At the same time, SD stream 137 will be showing the local programming that should have been inserted in the HD stream 136, had video or bitstream splicing actually been used. If HD stream 136 and SD stream 137 are correctly synchronized and the transition seamless, users will not notice anything. At the end of the local programming, IRDs switch back to the HD stream 136, until the next splicing point.

Time constraints must be considered, because the physical switch takes a significant amount of time, and IRD decoder buffers have a limited size. The present invention maintains a correct synchronization between the two streams and avoids clock discontinuities when switching between the streams. Unlike other types of decoding, such as DVD decoding, in a broadcast system as system 100, the IRD decoder does not have any control over the transmission bitrate. Thus, data cannot be read in “burst mode” when streams are switched, and thus the buffer 132 can go empty. Also, because data is always being broadcast (“pushed”), the decoder 131 cannot stop buffering input data at will, otherwise the buffer 132 will overflow.

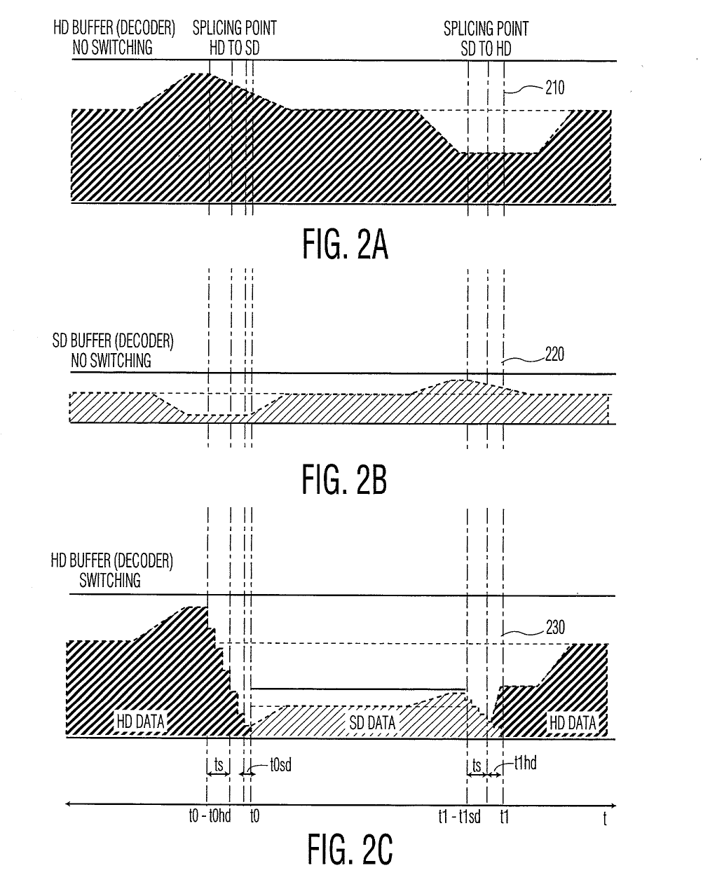

Referring now to FIG. 2, there are shown diagrams illustrating the variations of the average buffer occupancy against time for three different decoders 210, 220, 230. The first diagram shows the buffer occupancy versus time for a first decoder 210 corresponding to a HD decoder 210 which remains tuned to the HD program at all times. The HD encoder (e.g. 111) maintains an accurate model of the HD decoder 210 buffer occupancy and all decisions made by the bit rate control scheme are based upon it. The second decoder 220 corresponds to a SD decoder 220 that remains tuned to the SD program at all times. Similar to the HD encoder, the SD encoder 121 maintains an accurate model of the SD decoder 220 buffer occupancy. The third decoder 230 corresponds to a HD decoder 230 that switches to the SD stream upon detection of the first splicing point and then back to the initial HD stream upon detection of the second splicing point. HD decoder 230 represents the actions and state of decoder 131.

To illustrate the different mechanisms involved in the scheme of the present invention, consider the example of a switch between HD video stream 136 and SD video stream 137 by IRD 130. The switching of video steams is also applicable to a switch between two SD streams or two HD streams or, in general, to a switch between two different data streams, with appropriate changes to the decoder buffer sizes and the maximum delay that can be covered by the data buffered before the switch.

In essence, switching between two streams at the decoder side is equivalent to performing the splicing of two streams directly in the decoder buffer 132. Steps must be taken to ensure that this is correctly done and will not cause any buffer problems (overflow or underflow). Indeed, neither the HD encoder 111 nor the SD encoder 121 have the ability to monitor the buffer 132 level in the HD decoder 131 actually performing the stream switch. Both encoders assume that the decoder buffer level matches exactly the buffer level of the HD decoder 210 buffer model after a pair of stream switches (HD-to-SD and SD-to-HD). In other words, buffer levels of HD decoders (such as decoder 131) before and after each series of switches should match the buffer level of the HD decoder model 210 maintained by the HD encoder 111, whether they do perform the switches or not.

To do so, it is necessary to maintain a perfect synchronization between HD stream 136 and SD stream 137. They must have the same reference clock and PTSs. The splicing points in HD stream 136 and SD stream 137 should occur at the same time, for a same PTS. Ideally, even the GOP structure of the two streams should be identical, a picture and its equivalent in the other stream (time wise) being exactly of the same type (I, P, B, frame or field structure, top or bottom first, second or third field frame). However, this GOP structure synchronization is difficult to achieve. Thus, in an embodiment, the GOP structures are not required to be identical, but a closed GOP is required to start immediately after each splicing point. This condition is more fully described below.

In the example illustrated in FIG. 2, assume that the first splicing point occurs at time t₀ and the second at time t₁. If we assume that the two streams are correctly synchronized, a seamless transition can be obtained if the following conditions are respected:

t_{Ohd}≧tₛ+t_{Osd}

t_{Isd}≧tₛ+t_{Ihd}

where:

tₛ: time needed by the HD decoder 131 to switch and start looking for a new sequence header;

t_{Ohd}: period of time covered by the HD data in the buffer 132 when first switch occurs;

t_{Osd}: acquisition time needed to fill the decoder buffer 132 after first switch (SD VBV (video buffering verifier) delay);

t_{Isd}: period of time covered by the SD data in the buffer 132 when second switch occurs; and

t_{Ihd}: acquisition time needed to fill the decoder buffer 132 after second switch (HD VBV delay).

A typical value for tₛ is around 0.3 s. This value encompasses the tuning time (if the new program is transmitted on a different frequency) and the time necessary to acquire and process new descrambling keys (if Conditional Access is in use). Acquisition times (VBV delays) depend upon the size of decoder buffer 132 and the encoding bitrate. Encoders control the buffer occupancy in decoders and therefore set the acquisition time to a given value. Most of the time, if the encoding bitrate is fixed, the average acquisition time remains the same throughout the sequence. However, encoders might temporarily modify the average value in specific cases such as scene cuts or fades to allow for a better handling of the coding difficulty.

The applicable encoder determines the amount of data stored in buffer 132 just before the switch between the two streams. The maximum period of time that can be covered by the buffered data varies according to the maximum decoder buffer size and the encoding bitrate. The MPEG-2 specification gives a maximum VBV buffer size of 1.835008 Mbits for a SD stream and 7.340032 Mbits for a HD stream. For example, with a switching time of 0.3 s and a minimum acquisition time of 0.1 s, it is theoretically possible to achieve a seamless transition if there is about 0.5 s of video in the buffer when the switch occurs (0.3+0.1+margin to make up for inaccuracy in the synchronization of the two streams). Since the decoder buffer 132 has a maximum size, there is a limit on the maximum encoding bitrate that can be used to achieve a seamless transition. The limit is about 3.5 Mbit/s for a SD stream and 14 Mbit/s for a HD stream. The only way to increase the limit on the maximum bitrates is either to use bigger size decoder buffers (but they will not be MPEG-2 compliant) or decrease the time to be covered by the buffered data (which actually comes to decreasing tₛ).

In the present invention, encoders 111 and 121 are configured to perform two different tasks. They first have to set the decoder buffer occupancy to specific values before each splicing point, which requires a modification to the bitrate control mechanism. They also have to start a closed GOP right after the splicing point, whatever the position of the splicing point within the ongoing GOP. These tasks are described in further detail in the following two sections.

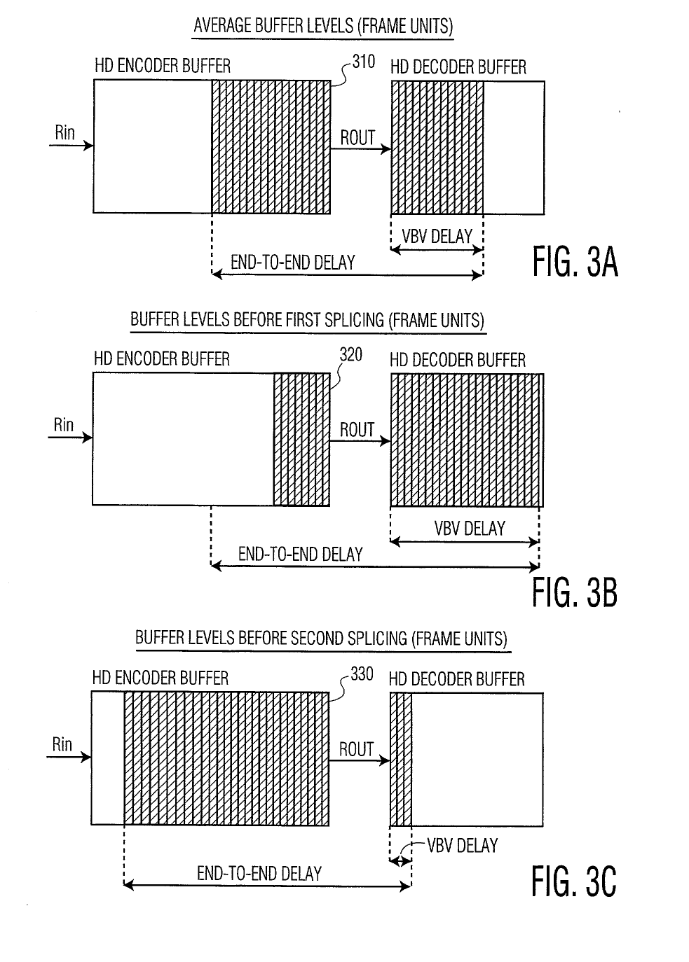

When switching from the HD stream 136 to the SD stream 137, the HD encoder 111 has to fill up the decoder buffer 132 to maximize t_{Ohd}. At the same time, the SD encoder 121 has to empty the hypothetical decoder buffer of SD decoder 220, to decrease as much as possible the acquisition time t_{Osd}. When switching back from SD to HD, it is the other way around. In this case, SD encoder 121 fills up the decoder buffer 132 to maximize t_{Isd}, while HD encoder 111 empties the hypothetical decoder buffer of HD decoder 210 to reduce t_{Ihd}. FIG. 3 shows the VBV delay variations for the HD streams. Those skilled in the art will appreciate that variations for the SD stream may be obtained by inverting the last two diagrams 320, 330 of FIG. 3.

The End-to-End delay shown in diagrams 310, 320, 330 corresponds to the total amount of time spent by any data to go through both encoder and decoder buffers. This delay is constant and can be expressed as a number of encoded frames. The VBV delay is the time spent by a given frame within the decoder buffer 132. The VBV delay is not necessarily a constant and its variations depend upon Rᵢₙ, the bitrate targeted for encoding, and Rₒᵤₜ, the transmission bitrate. For example, in diagram 310 the Rᵢₙ and Rₒᵤₜ are constant, demonstrating the average buffer level when a video stream is being broadcast without splicing and the VBV delay stays constant. Whenever Rᵢₙ and Rₒᵤₜ have different values, the VBV delay is modified accordingly. In diagram 320, just before splicing one video stream for another, Rᵢₙ becomes smaller than Rₒᵤₜ causing the VBV delay to increase (more frames present in HD decoder buffer). In diagram 330, just before the second video stream splicing, Rᵢₙ becomes greater than Rₒᵤₜ causing the VBV delay to drop (fewer frames present in HD decoder buffer).

Neither encoder has any control over Rₒᵤₜ, which is allocated by the multiplexer. However, the encoder can adjust Rᵢₙ such a way that the targeted VBV delay is reached before each splicing point. Splicing points must be known several GOPs in advance to allow for a smooth transition in the VBV value. A quick transition would only be achieved by an abrupt modification of the encoding bitrate, which could result in noticeable variations in the pictures' quality. Once the targeted VBV delay is reached, the encoder sets the encoding bitrate value back to Rₒᵤₜ. In a statistical multiplexing configuration, Rₒᵤₜ may be adjusted instead of Rᵢₙ if the encoder can directly request a given bitrate from the multiplexer.

It is assumed that both encoders accurately know the occurrence of each splicing point and it always corresponds to the end of a GOP for the first stream (HD stream 136 in our example). This latter constraint can be easily met if we assume that HD encoder 111 controls the insertion of splicing points. Assuming that the two streams are synchronized, i.e., that they share the same reference clock and they both use the same PTS/DTS values. If detelecine mode is in use, thus authorizing repeated fields to be dropped, it will be more difficult to maintain a perfect PTS/DTS synchronization between the two streams. Since the exact PTS/DTS value for which the splicing occurs is perfectly known several GOPs in advance, the SD encoder 121 can artificially repeat some fields if none of the upcoming frames (top field first) is correctly associated with this given PTS/DTS, until one finally is.

Alternatively, the IRD itself can handle PTS/DTS discontinuities at the splicing point, skipping or repeating a few fields to make up for the PTS/DTS differences between the two streams. As a general matter, skipping fields is preferable to repeating fields since a seamless transition is desired. However, repeating a couple of fields of the first stream before starting displaying pictures of the second stream should not be visible and the transition can still be considered as seamless.

As noted above, even if there is a perfect synchronization between the two streams (as far as reference clock and PTSs/DTSs are concerned), it is almost impossible to guarantee that the two streams will present the same GOP structure. In other words, even if the splicing point occurs at the end of a GOP for the first stream, that does not mean that the first picture after the splicing point is the first frame of a new GOP for the second stream. This is, however, mandatory if we want to avoid a PTS/DTS discontinuity. A new GOP, completely independent from the previous one (closed GOP), must start immediately after the splicing point. Encoders 111, 121 must therefore be able to modify the current encoding structure on the fly, without having to reset. This in essence means being able to have GOPs of different lengths and P periods of different sizes within the same sequence. For most encoders, modifying the length of a GOP should not be a problem but modifying the number of B pictures on the fly might be impossible. This could be due to the encoder pipeline initialization or the way the motion estimation chip works. If so, there could be a delay of up to the P period between the splicing point and the first frame of the new GOP. Once again, the only way to solve the problem is to implement in the IRD 130 a mechanism to repeat fields so as to make up for the missing ones. Alternatively, the new GOP may be started before the splicing point, while skipping the overlapping fields of the first stream in the IRD. Such a mechanism would allow the synchronization constraints between the two streams to be loosened while keeping the transition seamless.

A standard IRD may be modified as described below to implement IRD 130 to provide the seamless stream transition of the present invention.

First, IRD 130 must automatically switch to another stream upon detection of a splicing point, while continuing to decode the data already in the buffer 132. In one embodiment, the splicing information is conveyed for an ATSC (Advanced Television Systems Committee) video stream as follows: the adaptation field of an MPEG-2 transport stream has a 1 bit “splicing_point_flag”. When set to 1, it indicates that a “splice_countdown_field” shall be present in the associated adaptation field, specifying the occurrence of a splicing point. The “splice_countdown” is an 8 bit field, representing a value that may be positive or negative. A positive value specifies the number of remaining import packets of the same PID before the splicing point is reached. The splicing point is located immediately after the last byte of the transport packet in which the associated splice_countdown field reached zero. Both HD encoder 111 and SD encoders 121 have to insert the splicing information.

Such splicing information, however, can only indicate a switch between streams of same PID. However, in some cases an IRD needs to know not only at what time to switch, but also to what frequency (or channel or video and audio PIDS). Thus, in one embodiment, the Program and System Information Protocol (PSIP) is used in addition to the “splicing_point_flag”, to provide splicing information.

In addition to the splicing information, a new descriptor may also be created in the Virtual Channel Table (VCT). This descriptor can be designed to tell IRDs the switching time and the carrier frequency, as well as the PIDs of the streams for the new program. Also, this descriptor can tell local broadcasters when to insert local programming. The major fields of this descriptor may include: application time, duration, service type (SD or HD), carrier frequency, program number, PCR_PID, number of elementary streams, PID and stream type for each of the elementary streams, and whatever other information if necessary. The VCT is transmitted every 400 ms.

Table 1, below, provides an example of a possible descriptor:

TABLE 1

| Category | Information | Place |
|---|---|---|
| For program itself | carrier frequency | VCT table body |
| | program number | VCT table body |
| | service type (e.g. HDTV) | VCT table body |
| | number of elementary | service location descriptor |
| | streams | |
| | PID for ES 1 | service location descriptor |
| | stream type for ES 2 | service location descriptor |
| | (e.g. audio) | |
| | PID for ES 2 | service location descriptor |
| | field for additional info | service location descriptor |
| | if necessary | |
| For alternative | application time (the | |
| program | splicing point) | |
| | duration (e.g. 10 min.) | |
| | carrier frequency | alternative service location |
| | | descriptor |
| | program number | alternative service location |
| | | descriptor |
| | service type (e.g. SDTV) | alternative service location |
| | | descriptor |
| | number of elementary | alternative service location |
| | streams (e.g. 2) | descriptor |
| | stream type for ES 1 | alternative service location |
| | (e.g. video) | descriptor |
| | PID for ES 1 | alternative service location |
| | | descriptor |
| | stream type for ES 2 | alternative service location |
| | (e.g. audio) | descriptor |
| | PID for ES 2 | alternative service location |
| | | descriptor |
| | field for additional info | alternative service location |
| | if necessary | descriptor |

The information in the above descriptor combined with the splicing information will provide sufficient switching information. Given this switching information, which can be provided in advance of the splicing point, IRDs configured for HD usage will not only know the switching time, i.e., the splicing point, but also the frequency of the alternative program, PIDs of the video and audio streams, and so on. This permits the IRDs to start switching to the specified alternative program at the splicing point.

To switch back from the SD program 137 to the HD program 136, the SD encoder 121 needs also to send both the splicing information and the VCT with the similar descriptor. However, this time, the service type of the alternative program should be HDTV so that the IRDs configured for SD usage can ignore the switching signal.

As explained above, it is possible that there will not be a perfect synchronization between the 2 streams and PTS/DTS discontinuities might occur. Such discontinuities should be allowed around the splicing point and simply handled by freezing the last frame as long as the new PTS has not been reached. For most IRDs, this should not be a problem. PTSs discontinuities are usually handled in the same way, except that all the pointers are reset causing the data currently in the buffer to be lost. No reset is necessary in the splicing case since all the data in the buffer are supposedly valid.

The stream switching system and method of the present invention provides for a seamless splicing of two MPEG video streams directly in the decoder buffer 132. The VBV delay of both streams is adjusted in such a way that the VBV delay of the first stream covers the whole time needed to switch to the new stream and acquire new data. In an embodiment, the VBV delay of the new stream can be modified to reduce the acquisition time, thus decreasing the delay to be covered by the data from the old stream. It is also necessary to synchronize the two streams correctly, such that the two streams at least share the same reference clock (PCR samples). A completely seamless transition is possible if the two streams use exactly the same PTSs and present the same GOP structure, at least around the splicing point. Since such a high level of synchronization is hard to achieve, it is highly probable that a PTS discontinuity will be created at the splicing point.

In an embodiment, the stream switching of the present invention takes steps to try to reduce the discontinuity as much as possible, such as by modifying the GOP structure to ensure the start of a closed GOP as soon as possible after the splicing point or by adjusting the PTS values of the second stream (by repeating fields) to match the ones of the first stream. By doing so, the discontinuity at the splicing point should be no more than 4 fields (P period limited to a value of 3). The IRD 130 must ignore the discontinuity and freeze the last displayed frame until the new PTS is reached no more than 4 fields later. Even so, the transition may be considered to be “quasi-seamless”. Restrictions apply to the maximum encoding bitrates allowed for both streams during the splicing. Those restrictions are due to the decoder buffer size and the minimum period of time needed for the IRD to switch.

Those skilled in the art will appreciate that the stream switching of the present invention, described above primarily with reference to two video streams, which are extendable to other kinds of data streams, such as audio streams.

Aspects of the present invention can be embodied in the form of computer-implemented processes and apparatuses for practicing those processes. Various aspects of the present invention can also be embodied in the form of computer program code embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted as a propagated computer data or other signal over some transmission or propagation medium, such as over electrical wiring or cabling, through fiber optics, or via electromagnetic radiation, or otherwise embodied in a carrier wave, wherein, when the computer program code is loaded into and executed by a computer, the computer becomes an apparatus for practicing the invention. When implemented on a general-purpose microprocessor, the computer program code segments configure the microprocessor to create specific logic circuits to carry out the desired process.

The described system represents an advantageous method for doing business for a local broadcaster that cannot afford the capital investment in local HD transmitting equipment. The described system advantageously allows a local broadcaster to convey both high definition (HD) and standard definition (SD) video information to a consumer via a satellite link provided by a third party. The local broadcaster need not invest in expensive HD broadcast equipment, while retaining the ability to switch between HD and local SD programming, e.g., including local news and commercials that will generate revenue to support the local broadcaster. As explained in detail previously, in the context of an MPEG encoded signal, filling a (vbv) buffer with an appropriate amount of HD material enables a seamless transition from HD to SD program material, and vice-versa in the case of an SD to HD transition.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1. A method for processing packetized video data, comprising the steps of:
receiving encoded data representing a first video program having a first display resolution;
receiving encoded data representing a second video program of a second display resolution lower than said first display resolution;
generating transmission identification information for signaling a transition from said first display resolution program to said second display resolution program;
incorporating said first video program encoded data and said second video program encoded data and said identification information into packetized data; and
providing said packetized data for output to a transmission channel.

2. The method of claim 2, wherein said transition is a seamless transition.

3. The method of claim 1, further comprising the step of upconverting the decoded second resolution data in a decoder to provide commercials of first resolution for seamless insertion in the video program.

4. The method of claim 1, wherein the second video program is a video commercial.

5. The method of claim 1, wherein the first video program is a network video feed and the second video program is a local video program.

6. The method of claim 1, wherein the second video program is a local news program.

7. The method of claim 1, wherein said encoded data representing the first video program is generated by a network station and said encoded data representing the second video program are generated by a local station.

8. The method of claim 7, wherein said packetized data are output to a transmission channel by a satellite.

9. A method for decoding image representative input data representing a video program of a first display resolution and incorporating video segments of a lower second display resolution, comprising the steps of:
identifying encoded data representing a video program of a first display resolution;
identifying encoded data representing a video segment of a second display resolution lower than said first display resolution for insertion within said video program;
acquiring identification information for signaling a transition from said first display resolution to said second display resolution; and
decoding said video program encoded data and said video segment encoded data to provide a decoded first resolution data output and a decoded second resolution data output respectively using said identification information; and
formatting said first and second resolution decoded data outputs for display.

10. The method of claim 9, further comprising the step of upconverting the decoded second resolution data to provide video segment data of first resolution for seamless insertion in the video program.

11. The method of claim 9, wherein the video segment represents a video commercial.

12. The method of claim 9, wherein the first video program is a network video feed and the video segment is a local video program.

13. The method of claim 9, wherein the video segment is a local news program.

14. The method of claim 9, wherein said encoded data representing the first video program is generated by a network station and said encoded data representing the video segment are generated by a local station.

15. The method of claim 14, wherein said packetized data are output to a transmission channel by a satellite.

16. A method according to claim 9, wherein said decoding step comprises the step of storing both data representing said video program and data presenting said video segment in a buffer.

17. A method according to claim 16, wherein said buffer normally stores video data of said first, higher, display resolution.

18. A method according to claim 17, wherein said buffer is MPEG compliant.

19. A video broadcasting method comprising the steps of:
receiving high definition video information from a network provider;
translating the received high definition video information to lower definition video information;
providing local video information at lower definition; and
transmitting the translated lower definition video information and the lower definition local information in a datastream to a satellite via an uplink path.

20. A method according to claim 18, wherein:
the high definition video information is high definition television information; and
the lower definition information includes at least one of standard definition television program information, news, and commercials.
